(19) United States
(12) Patent Application Publication
(10) Pub. No.: US 2026/0236826 A1
(43) Pub. Date: Aug. 13, 2026

(54) IDENTIFYING FORMATION TYPES USING SURVEY DATA

(71) Applicant: Schlumberger Technology Corporation, Sugar Land, TX (US)

(72) Inventors: Shashin Sharan, Houston, TX (US); Per Irgens, Houston, TX (US); Kaustubh Shrivastava, Houston, TX (US)

(21) Appl. No.: 19/050,256

(22) Filed: Feb. 11, 2025

(51) Int. Cl. G06N 20/00; E21B 49/00

(52) U.S. Cl. CPC G06N 20/00; E21B 49/00; E21B 2200/20; E21B 2200/22

(57) ABSTRACT

A formation identification system may receive input data, the input data including sensor data for a wellbore along a wellbore length of the wellbore. A formation identification system may apply a machine learning model to the input data to generate an output including a formation type for at least one location along the wellbore length of the wellbore, wherein the machine learning model is trained to generate a predicted formation type based on a dataset.

### BACKGROUND OF THE DISCLOSURE

Wellbores are drilled through multiple geological formations. The identification of certain geological formations may be challenging using sensor measurements, such as wireline sensor measurements, without correlation with ground-truth measurements. For example, water-bearing tuff and oil-bearing sandstone formations may be impossible to distinguish, even for trained specialists.

### SUMMARY

In some aspects, the techniques described herein relate to a method for identifying a formation type. A formation identification system receives input data, the input data including sensor data for a wellbore along a wellbore length of the wellbore. The formation identification system applies a machine learning model to the input data to generate an output including a formation type for at least one location along the wellbore length of the wellbore. The machine learning model is trained to generate a predicted formation type based on a dataset.

In some aspects, the techniques described herein relate to a method for identifying a formation type in a wellbore. A formation identification system receives a training dataset. The training dataset includes training data logs and ground-truth measurements. The formation identification system correlates a formation type at a wellbore depth in the ground-truth measurements with sensor measurements in the training data logs at the wellbore depth. The machine learning model is trained, using the training dataset and the correlated formation type, to identify a predicted formation type based on input data.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a conveyance system for performing a conveyance operation within a wellbore, according to at least one embodiment of the present disclosure.

FIG. 2 is a schematic representation of a formation identification system, according to at least one embodiment of the present disclosure.

FIG. 3 is a schematic representation of a formation identification system, according to at least one embodiment of the present disclosure.

FIG. 4 is a schematic representation of a formation identification system, according to at least one embodiment of the present disclosure.

FIG. 5 is a schematic representation of a formation identification system, according to at least one embodiment of the present disclosure.

FIG. 6 is a flowchart of a method for identifying a formation in a wellbore, according to at least one embodiment of the present disclosure.

FIG. 7 is a flowchart of a method for identifying a formation in a wellbore, according to at least one embodiment of the present disclosure.

FIG. 8 is a representation of a computing system, according to at least one embodiment of the present disclosure.

### DETAILED DESCRIPTION

This disclosure generally relates to devices, systems, and methods for identifying formation types based on survey data. A wellbore in the earth extends through multiple different geological formations, which may be formed from different rock types and/or have different properties. A particular formation may be of interest to an operator based on its properties. For example, some oil reservoirs are located in a particular formation. An oil and gas operator may desire to perforate the formation to increase the oil recovery from that formation. However, other formations may include water. In an oil and gas wellbore, perforating a formation containing water may decrease the oil cut in the produced fluids (e.g., increase the water cut), thereby reducing the overall oil production from the wellbore. But some oil-bearing formations and water-bearing formations may have similar survey signatures, including the survey signatures of multiple different type of survey logs. Indeed, trained and experienced petrologists often fail to identify or distinguish formation types based on survey logs. This may make it difficult to reliably identify the formation of interest. Incorrect formation identification may result in inefficient and/or unsatisfactory completion processes, such as the perforation of a water-bearing formation rather than the perforation of an oil-bearing formation.

In accordance with at least one embodiment of the present disclosure, a formation identification model may be trained to identify formations known or suspected to contain oil and formations known or suspected to contain water. The formation identification model may be trained on a training dataset including training data logs and ground-truth measurements. The ground-truth measurements may be correlated with the training data logs. For example, the ground-truth measurements may identify a formation type by depth (including starting depth and ending depth, with the associated thickness). The formation type depths, as identified by the ground-truth measurements, may be correlated with the depths of the measured survey data in the training data logs. The survey data correlated with the formation type depths may then be used to train the machine learning model.

The trained machine learning model may then be applied to uncorrelated survey data along a wellbore length of the wellbore. The uncorrelated survey data may not have associated formation depth identifications. The trained machine learning model may generate formation identification based on the uncorrelated survey data. In manner, the formation identification model may identify formations using the survey measurements.

In some embodiments, the training data may be rebalanced to balance the number of instances of a particular formation type. For example, a certain formation type may be predominant or rare in a particular geological basin. During training, the machine learning model may over or under-identify the formation type. The training data may be rebalanced by identifying the number of instances of the formation type, or a ratio of the instances of two or more formation types. Rebalancing the training data may include interpolating and generating rebalancing training data logs and associated rebalancing training ground-truth measurements to generate an equal or approximately equal distribution of formations of interest. This may help to improve the accuracy of the machine learning model.

As illustrated by the foregoing discussion, the present disclosure utilizes a variety of terms to describe features and advantages of the formation identification system. Additional detail is now provided regarding the meaning of such terms. For example, as used herein, the term “survey data” refers to information collected during a survey of a wellbore. In particular, the term “survey data” may include survey data collected from sensors inserted in a wellbore along the wellbore length. To illustrate, survey data may include survey data collected during a wireline survey (e.g., wireline sensor data). In some embodiments, the survey data may be collected from one or more sensors on an intervention system, such as a coil tubing system. In some embodiments, the survey data may be collected from one or more sensors on a bottom-hole assembly (BHA) of a drilling system, including during a downhole drilling operation (including drilling, reaming, or otherwise degrading a formation with a wellbore). Survey data may include any type of survey data log along the wellbore length. Examples of survey data logs may include a resistivity log, a spontaneous potential log, a porosity log, a density log, a clay volume log, an effective porosity log, visual images, gravitation logs, any other survey data log, and combinations thereof, including inclusions and exclusions of any of the foregoing.

As used herein, the term “ground-truth measurement” refers to confirmed identifications of a formation. In particular, the term “ground-truth measurement” may include identification of a formation type using measurements of physical samples of the formation. To illustrate, a ground-truth measurement may include a survey from a mud log. A mud log may be a measurement of the cuttings collected from the drilling fluid while the wellbore is being drilled. An operator may collect the cuttings and analyze their content to identify properties of the formation, including the rock type, composition, porosity, and other properties of the formation. In some examples, a ground-truth measurement may include an analysis of a set of cores collected from the geological basin. A geological core may be a cylindrical sample of a rock that is collected using a specialized bit and drilling assembly to drill an annular hole in the formation, leaving the cylindrical sample of rock available for collection. The cylindrical sample of rock is then collected from the drilled hole and analyzed at the surface. The ground-truth measurements may include any other type of ground truth measurements, including physical measurement, optical measurement, chemical measurements, or any other properties that may be used to identify a particular formation type or formation of interest. In some embodiments, the ground truth-measurements may include the raw data used to identify the formation type. In some embodiments, the ground-truth measurements may include the identified formation type. In some embodiments, the ground-truth measurements may include both the raw data and the identified formation type.

As used herein, the term “machine learning” refers to algorithms that generate data-driven predictions or decisions from known input data by modeling high-level abstractions. Examples of machine-learning models include computer representations that are tunable (e.g., trainable) based on inputs to approximate unknown functions. For instance, a machine-learning model includes a model that utilizes algorithms to learn from, and make predictions on, known data by analyzing the known data to learn to generate outputs that reflect patterns and attributes of the known data. For example, machine-learning models include latent Dirichlet allocation (LDA), multi-arm bandit models, linear regression models, classification models, logistical regression models, random forest models, support vector machines (SVMs) models, neural networks (convolutional neural networks, recurrent neural networks such as LSTMs, graph neural networks, etc.), or decision tree models.

A machine learning model may be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning model may include one or multiple machine learning models that cooperatively generate one or more outputs based on corresponding inputs.

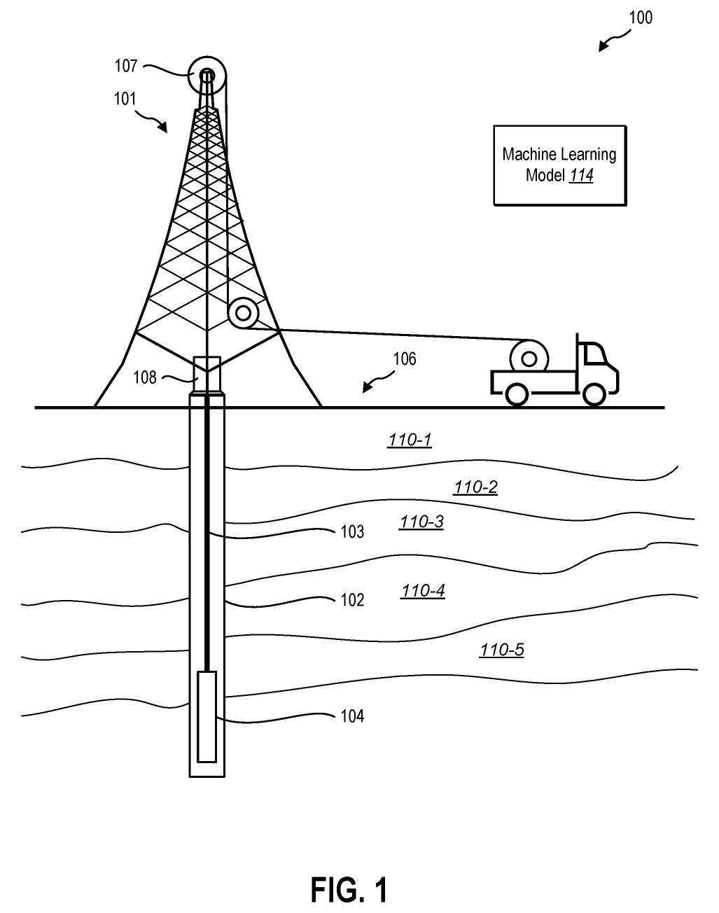

Additional details will now be provided regarding systems described herein in relation to illustrative figures portraying example implementations. For example, FIG. 1 shows one example of a conveyance system 100 for performing a conveyance operation within a wellbore 102, with which a survey may be performed to collect survey data along the wellbore length of the wellbore 102. The conveyance system 100 includes a rig, mast, or derrick 101 used to support a conveyance line 103 (e.g., WL line or CT line) at a surface 106. The conveyance line 103 may be suspended, inserted into, or otherwise positioned within the wellbore 102. For instance, the conveyance line 103 may pass through a wellhead 108. The wellhead 108 may provide a structural, pressure, and/or fluid barrier between the wellbore and the surface 106. For instance, the wellhead 108 may contain wellbore fluids within the wellbore 102. In some embodiments, surface equipment of the conveyance system 100 includes an injector head for conveying the conveyance line 103 within the wellbore. For example, an injector head may include one or more (e.g., hydraulic) drives, chain assemblies, grip assemblies, or other components for providing a tractive effort for running and/or retrieving the conveyance line 103 into and/or from the wellbore 102.

The wellbore 102 may extend through a subsurface and may traverse various formations, layers, strata, or other subterranean features (collectively formations 110). The wellbore 102 may be a completed (e.g., fully drilled or fully formed) wellbore, or may be a wellbore at any intermediate stage of completion. The wellbore 102 is depicted as extending substantially straight or vertical into the ground, however, the wellbore 102 may be formed in accordance with any trajectory. For example, the wellbore 102 can include one or more bends, doglegs, inclinations, etc., such that the wellbore 102 may exhibit any level of deviation or tortuosity, including in 3-dimensional space.

The conveyance line 103 is connected to a downhole tool 104 for supporting or positioning the downhole tool 104 in the wellbore 102. The downhole tool 104 may be a logging tool, a completion tool, a production tool, or any other tool used for performing any downhole operation, such as for imaging or otherwise measuring characteristics of the wellbore 102 or subsurface, performing a perforation, setting a plug, retrieving lost or stuck equipment, isolating wellbore sections, testing wellbore integrity, sampling fluids, wellbore cleaning, wellbore repair, opening or closing valves, stimulation (e.g., fracking), circulating fluid, downhole communication, or any other tool for performing any other downhole function.

In accordance with at least one embodiment of the present disclosure, the downhole tool 104 may include a survey tool. The survey tool may include one or more sensors. Each sensor may be associated with one or more survey data logs. For example, a sensor may perform measurements that may be collected as the survey data log. The sensor measurements in the survey data logs may be correlated with a depth or location in the wellbore 102. This may allow the operator to associate the survey data log information with a particular depth or location.

The wellbore 102 may extend through multiple formations 110. For example, in the embodiment shown, the wellbore 102 extends through a first formation 110-1, a second formation 110-2, a third formation 110-3, a fourth formation 110-4, and a fifth formation 110-5. Based on the geology of the area, the formations 110 may have different lithology. As a specific, non-limiting example, at least one of the formations 110 may be formed from sandstone and at least one of the formations 110 may be formed from tuff. However, it should be understood that the techniques of the present disclosure may be applied to any formation formed from any rock type, including sedimentary rocks, metamorphic rocks, volcanic rocks, and specific types of rocks from within these broad categories.

As discussed herein, in some situations, the survey data logs from the downhole tool 104 may be very similar between two formations 110. For example, water-bearing tuff and oil-bearing sandstone may have similar resistivity logs, density logs, and clay volume logs, as measured by the sensors on the downhole tool 104. An operator, including a trained petrologist, may fail to accurately identify and/or distinguish water-bearing tuff and oil-bearing sandstone from these survey data logs. Misidentification of the oil-bearing sandstone and water-bearing tuff may result in the perforation of the wrong formation, or the failure to perforate a desired formation.

In some embodiments, the wellbore 102 may be used to generate ground-truth measurements of the formation type and other formation properties of the formations 110. For example, while drilling the wellbore 102, the operator may collect cuttings removed from the wellbore 102, associate the cuttings with a depth or location at which they were drilled, and identify formation information from the collected cuttings. This may allow the operator to definitively identify the formation type for the various formations 110.

As discussed in further detail herein, the survey data logs and the ground-truth measurements for the wellbore 102 may be used to train a machine learning model 114 to identify formations 110 of interest. The machine learning model 114 may utilize multiple inputs, including multiple survey data feeds, and the ground-truth measurements as training data. The machine learning model 114 may output, upon the input of new survey data logs, estimated ground-truth measurements and/or formation type.

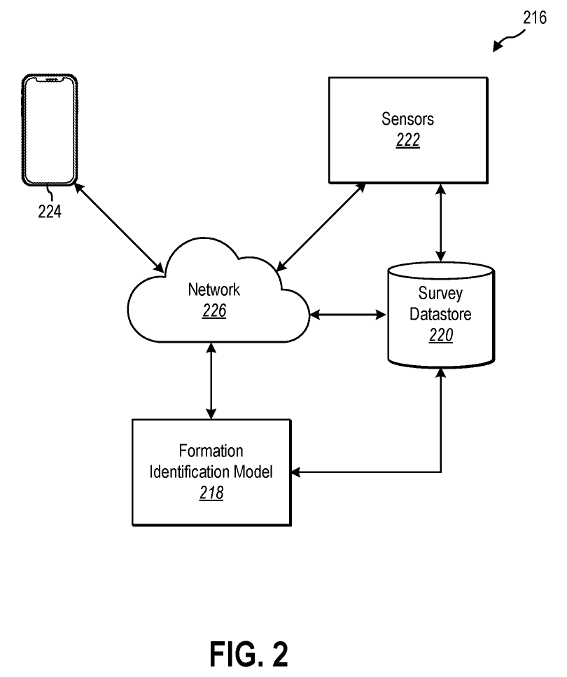

FIG. 2 is a schematic representation of a formation identification system 216, according to at least one embodiment of the present disclosure. The formation identification system 216 may include a formation identification model 218. The formation identification model 218 may be a machine learning model, as discussed herein.

The formation identification system 216 may include one or more sensors 222. The sensors 222 may be used to generate survey data regarding the wellbore along a wellbore length of the wellbore. For example, the sensors 222 may include wireline sensors or other survey sensors that may be used to generate survey data logs. The sensors 222 may store the survey data logs in a survey datastore 220. The survey datastore 220 may include a database of stored historical survey data logs. The historical survey data logs may include identification information, including hole ID, location information, geological basin information, equipment information used at the wellbore, and so forth. The historical survey data logs may include any survey data logs discussed herein. In some embodiments, different survey data logs in the survey datastore 220 may have different types of survey measurements, or a different collection of survey data logs. In some embodiments, each of the survey data logs in the survey datastore 220 may have the same types of survey measurements, or the same collection of survey data logs. In some embodiments, the survey datastore 220 may further include ground-truth measurements. The ground-truth measurements may be listed by depth or location in the wellbore. In some embodiments, the ground-truth measurements may be correlated with the survey data logs by depth.

A user may analyze a wellbore and/or make a plan for a wellbore completion. The user may, on a user device 224 access the survey datastore 220 over a network 226, such as the internet. For example, the survey datastore 220 may be stored on remote storage, such as cloud storage or other remote storage. However, it should be understood that at least a portion of the survey datastore 220 may be stored locally on the user device 224. The user device 224 may include any user device, such as a mobile phone, a tablet, a laptop computer, a desktop computer, any other user device, and combinations thereof.

In some embodiments, the user may supervise training of the formation identification model 218. For example, the user may input survey data logs and ground-truth measurements from the survey datastore 220 to the formation identification model 218. The user may cause the formation identification model 218 to be trained to identify the ground-truth measurements (including formation identification) based on input survey data logs.

For example, in a wellbore having no ground-truth measurements taken to identify the formations, the user may input the survey data logs to the formation identification model 218. The formation identification model 218 may, based on the input survey data logs, generate an output. The output may include estimated or predicted ground-truth measurements. In some embodiments, the output may include formation type. For example, the output may include the identification of a formation of interest and the depth associated with the formation of interest. In some embodiments, the output may include the identification of more than one formation of interest. In some embodiments, the output may include an identification of all of the formations in the wellbore.

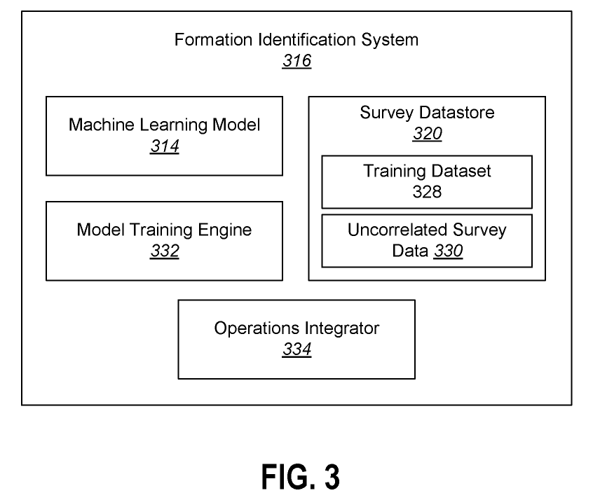

FIG. 3 is a schematic representation of a formation identification system 316, according to at least one embodiment of the present disclosure. Each of the components of the formation identification system 316 can include software, hardware, or both. For example, the components can include one or more instructions stored on a computer-readable storage medium and executable by processors of one or more computing devices, such as a client device or server device. When executed by the one or more processors, the computer-executable instructions of the formation identification system 316 can cause the computing device(s) to perform the methods described herein. Alternatively, the components can include hardware, such as a special-purpose processing device to perform a certain function or group of functions. Alternatively, the components of the formation identification system 316 can include a combination of computer-executable instructions and hardware.

Furthermore, the components of the formation identification system 316 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The formation identification system 316 may include a machine learning model 314. A survey datastore 320 may store survey data logs. For example, the survey datastore 320 may include a training dataset 328. The training dataset 328 may include survey data logs that are correlated with ground-truth measurements. Put another way, the training dataset 328 may include multiple data logs for one or more wellbores. The training dataset 328 data logs may include separate survey data logs for different survey types and measurements, including a ground-truth measurement data log.

The training dataset 328 may originate from any source. For example, the training dataset 328 may include survey data logs from multiple offset wellbores. The offset wellbores may intersect the same formation, reservoir, or geographical area. In some embodiments, the offset wellbores may be from the same geological basin. In some embodiments, the offset wellbores may be from an area having the same general geology, including similar stratigraphic layers and patterns. In some embodiments, the training dataset 328 may originate from wellbores outside of the geological basin or geographical area.

The machine learning model 314 may be trained based on the training dataset 328. For example, the training dataset 328 may be separated into a training subset and a validation subset. The machine learning model 314 may be trained or fine-tuned using the training subset. During training, the machine learning model 314 may associate one or more of the data values, trends, or elements of the measurements of the survey data logs with the ground-truth measurements. In some embodiments, the machine learning model 314 may generate one or more additional parameters based on the survey data logs. For example, the machine learning model 314 may perform a mathematical function on two or more of the measurements from the training dataset 328 (including addition, subtraction, multiplication, division, exponents, logarithms, and so forth). These additional parameters may be used to identify a correlation between the survey data logs and the ground-truth measurements.

The formation identification system 316 may include a model training engine 332. The model training engine 332 may supervise or facilitate training of the machine learning model 314. For example, the model training engine 332 may separate the training dataset 328 into training subsets and validation subsets. The model training engine 332 may input the training subset into the machine learning model 314 to train or fine-tune the machine learning model 314. After training, the model training engine 332 may validate the model using the validation subsets. During validation, the model training engine 332 may input the validation survey data logs without the correlated validation ground-truth measurements. The machine learning model 314 may output predicted ground-truth measurements. The model training engine 332 may compare the predicted ground-truth measurements to the validation ground-truth measurements. If the predicted ground-truth measurements do not match the validation ground-truth measurements, then the model training engine 332 may re-train the machine learning model 314, or cause further fine-tuning of the machine learning model 314. For example, the model training engine 332 may adjust one or more parameters of the machine learning model 314 to improve the accuracy of the machine learning model 314.

In some embodiments, the model training engine 332 may validate the machine learning model 314 by confirming a balance of the training dataset 328. For example, and referring to the example illustrated in FIG. 1, the validation ground-truth measurements may include four formations 110 formed from water-bearing tuff, and one formation 110 formed from oil-bearing sandstone. The predicted ground-truth measurements may include three formations 110 formed from water-bearing tuff, and two formations 110 formed from oil-bearing sandstone. The model training engine 332 may notice this discrepancy and rebalance the training dataset 328. Rebalancing the training dataset 328 may include interpolating the sensor data and the ground-truth measurements in the training dataset 328 and generating new or artificial sensor data and ground-truth measurements, to generate an equal or approximately equal distribution of formation types in the training dataset 328. In some embodiments, the training dataset 328 may be rebalanced using a synthetic minority oversampling technique (SMOTE) and/or undersampling techniques. Rebalancing the training dataset 328 may facilitate an improved accuracy of the machine learning model 314, including increasing the accuracy of the ratio of certain formations.

In some embodiments, the machine learning model 314 may output a confidence score. The confidence score may be a representation of the confidence of the machine learning model 314 in the predicted ground-truth measurements. For example, a low confidence score may reflect a scenario in which the predicted ground-truth measurements by the machine learning model 314 are less likely to reflect the actual conditions in the wellbore.

When the machine learning model 314 is trained, the machine learning model 314 may be applied to uncorrelated survey data 330. Put another way, the uncorrelated survey data 330 may be used as input to the machine learning model 314. The machine learning model 314 may prepare, as output, predicted ground-truth measurements. For example, the machine learning model 314 may output the predicted measurements (e.g., predicted raw data) that may be used to identify the formation type, or the rock type of the formation. In some embodiments, the machine learning model 314 may output the predicted formation type.

The predicted ground-truth measurements and/or the predicted formation type may be used in operational decisions. For example, the predicted formation type may be used to identify a portion or portions of the wellbore to perforate and/or identify a portion or portions to perform hydraulic fracturing (e.g., fracking). In some examples, the predicted formation type may be used in other completion processes, including the placement of various completion equipment, such as valves, packers, electric submersible pumps (ESPs), any other completion equipment, and combinations thereof, including inclusions and exclusions of any of the foregoing.

In accordance with at least one embodiment of the present disclosure, an operations integrator 334 may use the predicted ground-truth measurements and/or the predicted formation type in modeling and planning processes. For example, the operations integrator 334 may include a completion planning model. The completion planning model may use the predicted formation type to make one or more completion plans, such as a plan to perform perforation operations, fracking operations, the installation of completion equipment, and so forth. In some embodiments, the operations integrator 334 may automatically generate an operations plan using the predicted formation type.

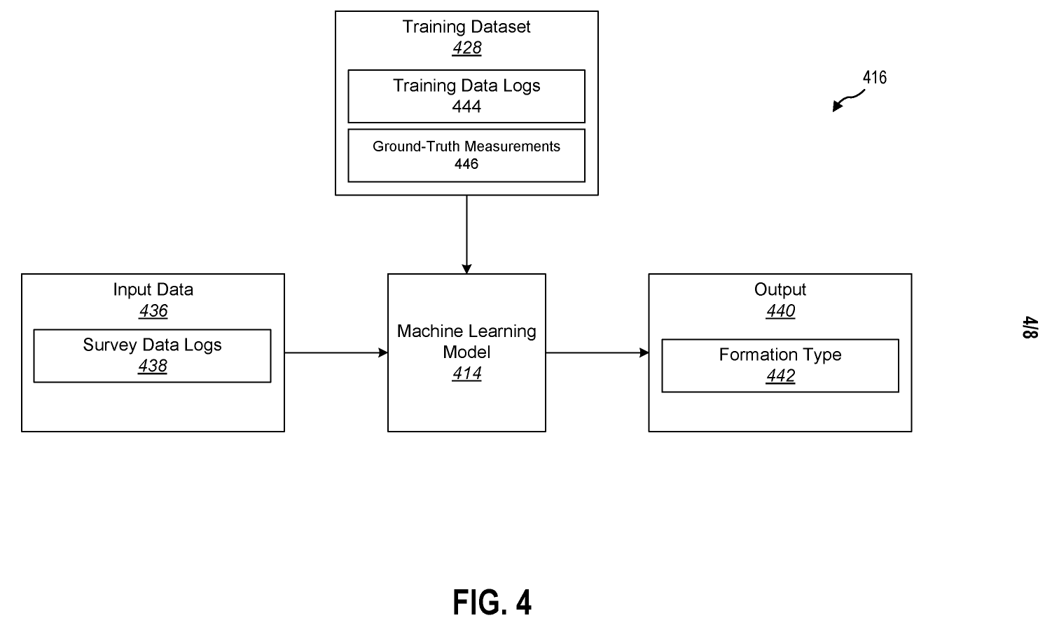

FIG. 4 is a schematic representation of a formation identification system 416, according to at least one embodiment of the present disclosure. In the formation identification system 416, a machine learning model 414 may receive an input of input data 436. The input data 436 may include survey data logs 438. As discussed herein, the survey data logs 438 may include the sensor data measured in the wellbore, including sensor data measured using one or more sensors on a wireline tool.

As discussed herein, the machine learning model 414 may be trained to output an output 440 based on the input data 436. The output 440 may include a formation type 442. For example, the machine learning model 414 may be trained to identify the formation type 442 based on input survey data logs 438.

The machine learning model 414 may be trained on a training dataset 428. The training dataset 428 may include training data logs 444 and ground-truth measurements 446. In some embodiments, the data logs 444 may be correlated by wellbore depth with the ground-truth measurements.

The machine learning model 414 may be any type of model. For example, the machine learning model 414 may include a classification model that identifies the class or classes of formation type 442 based on the survey data logs 438 input data.

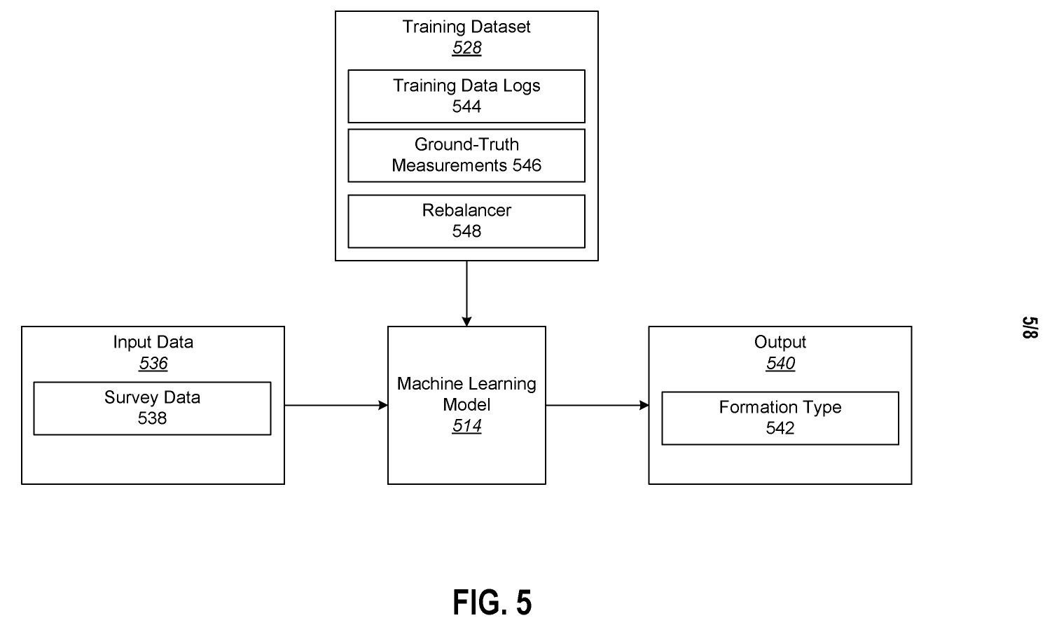

FIG. 5 is a schematic representation of a formation identification system 516, according to at least one embodiment of the present disclosure. In the formation identification system 516, a machine learning model 514 may receive an input of input data 536. The input data 536 may include survey data logs 538. As discussed herein, the survey data logs 538 may include the sensor data measured in the wellbore, including sensor data measured using one or more sensors on a wireline tool.

As discussed herein, the machine learning model 514 may be trained to output an output 540 based on the input data 536. The output 540 may include a formation type 542. For example, the machine learning model 514 may be trained to identify the formation type 542 based on input survey data logs 538. The machine learning model 514 may be trained on a training dataset 528. The training dataset 528 may include training data logs 544 and ground-truth measurements 546. In some embodiments, the data logs 544 may be correlated by wellbore depth with the ground-truth measurements. The machine learning model 514 may be any type of model. For example, the machine learning model 514 may include a classification model that identifies the class or classes of formation type 542 based on the survey data logs 538 input data.

In some situations, the formations of interest, or the formations identified in the ground-truth measurements 546, may have an uneven distribution. For example, a first formation may be present with a much higher number of instances or depth range than a second formation. Training the machine learning model 514 on an uneven distribution of formations may result in the machine learning model 514 preferentially and inaccurately identifying the second formation as the first formation.

In accordance with at least one embodiment of the present disclosure, the training dataset 528 may be rebalanced. For example, a rebalancer 548 may analyze the ground-truth measurements 546 from the training dataset 528. The rebalancer 548 may determine a ratio of formation types in the ground-truth measurements 546. In some embodiments, the rebalancer 548 may interpolate, from the data logs 544 and the ground-truth measurements 546, rebalancing ground-truth measurements. The rebalancing ground-truth measurements may be added to the training dataset 528 to generate an equal or relatively equal number of matched ground-truth measurements 546. In this manner, the rebalancer 548 may facilitate training of the machine learning model 514 to reliably and accurately identify the desired formations.

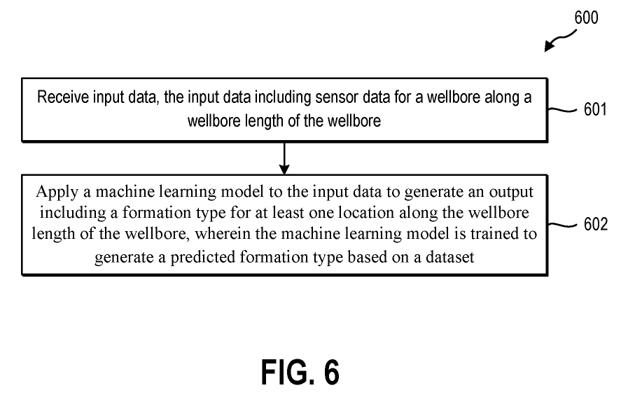

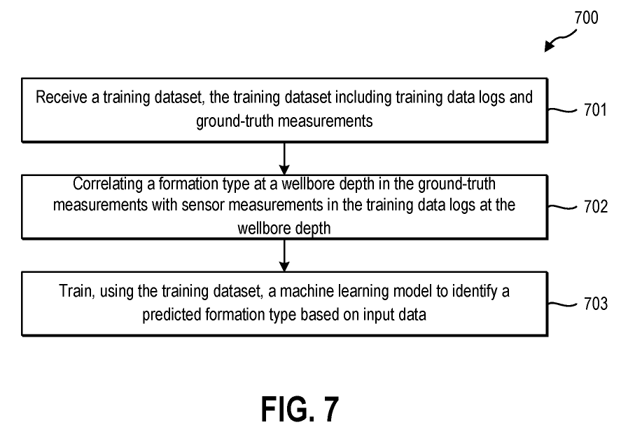

FIG. 6 and FIG. 7, the corresponding text, and the examples provide a number of different methods, systems, devices, and computer-readable media of the formation identification system. In addition to the foregoing, one or more embodiments can also be described in terms of flowcharts comprising acts for accomplishing a particular result, as shown in FIG. 6 and FIG. 7. FIG. 6 and FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts or a method 600 for identifying a formation type using survey data logs, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

A formation identification system may receive input data at 601. The input data may include sensor data for a wellbore along a wellbore length of the wellbore. The formation identification system may apply a machine learning model to the input data to generate an output including a formation type for at least one location along the wellbore length of the wellbore at 602. The machine learning model is trained to generate a predicted formation type based on a dataset. For example, the machine learning model may be applied to a survey data log for a wellbore. The machine learning model may output the predicted formation type based on the survey data logs.

In some embodiments, the sensor data includes at least one of a resistivity log, a spontaneous potential log, a porosity log, a density log, a clay volume log, or an effective porosity log. In some embodiments, the sensor data includes three data logs, consisting of a resistivity log, an SP log, and a clay volume log. In some embodiments, the input data or the sensor data includes wireline sensor data.

In some embodiments, the formation identification system trains the machine learning model with a training dataset. The training dataset includes training data logs that are correlated with ground-truth measurements. The ground-truth measurements may include mud logs. In some embodiments, the training data logs are collected from the same geological basin.

In some embodiments, as discussed herein, the formation identification system receives new ground-truth measurements for the input data, compares the new ground-truth measurements to the output, and trains the machine learning model based on the comparison between the new ground-truth measurements and the output. In some embodiments, the formation identification system rebalances the training dataset based on a number of instances of a formation type in the output. In some embodiments, the number of instances may be based on the number of instances in the training dataset.

In some embodiments, the machine learning model includes a classification model.

In some embodiments, the formation type includes water bearing tuff or oil bearing sandstone. In some embodiments, the machine learning model is trained to distinguish between the water bearing tuff and the oil bearing sandstone.

In some embodiments, the formation identification system generates a completion plan based on the formation type at the at least one location.

As mentioned, FIG. 7 illustrates a flowchart of a series of acts or a method 700 for identifying a formation type using survey data logs, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

A formation identification system may receive a training dataset at 701. The training dataset may include training data logs and ground truth measurements. The formation identification system may correlate a formation type at a wellbore depth in the ground-truth measurements with sensor measurements in the training data logs at the wellbore depth at 702. The formation identification system may train, using the training dataset, a machine learning model to identify a predicted formation type based on input data at 703.

In some embodiments, the formation identification system may identify an amount of the formation type in the wellbore and rebalance the training data logs based on the amount of the formation type.

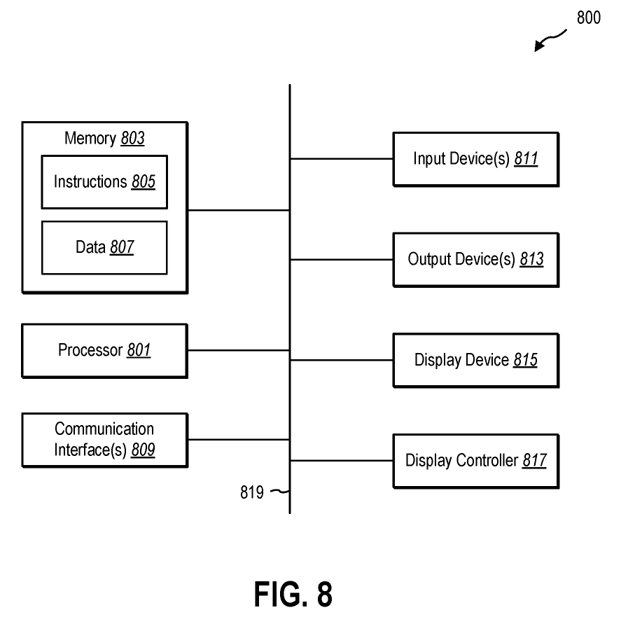

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The embodiments of the formation identification system have been primarily described with reference to oil and gas operations; the formation identification systems described herein may be used in applications other than at a wellbore. In other embodiments, formation identification systems according to the present disclosure may be used outside a wellbore or other downhole environment used for the exploration or production of natural resources. For instance, formation identification systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for identifying a formation type, the method comprising:
receiving input data, the input data including sensor data for a wellbore along a wellbore length of the wellbore; and
applying a machine learning model to the input data to generate an output including a formation type for at least one location along the wellbore length of the wellbore, wherein the machine learning model is trained to generate a predicted formation type based on a dataset.

2. The method of claim 1, wherein the sensor data includes at least one of a resistivity log, a spontaneous potential log (SP), a porosity log, a density log, a clay volume log, or an effective porosity log.

3. The method of claim 2, wherein the sensor data consists of the resistivity log, the SP log, and the clay volume log.

4. The method of claim 1, wherein the sensor data includes wireline sensor data.

5. The method of claim 1, further comprising training the machine learning model with a training dataset, the training dataset including training data logs correlated with ground-truth measurements.

6. The method of claim 5, wherein the ground-truth measurements include mud logs.

7. The method of claim 5, further comprising:
receiving new ground-truth measurements for the input data;
comparing the new ground-truth measurements to the output; and
training the machine learning model based on the comparison between the new ground-truth measurements and the output.

8. The method of claim 7, further comprising rebalancing the training dataset based on a number of instances of a formation type in the output.

9. The method of claim 8, wherein the number of instances of the formation type is based on the number of instances of the formation type in the training dataset.

10. The method of claim 8, wherein rebalancing the training dataset is based on a validation of the machine learning model using a validation data subset of the training data.

11. The method of claim 1, wherein the machine learning model includes a classification model.

12. The method of claim 1, wherein the formation type includes water bearing tuff or oil bearing sandstone.

13. The method of claim 12, wherein the machine learning model is trained to distinguish between a water-bearing tuff and an oil-bearing sandstone.

14. The method of claim 1, further comprising generating a completion plan based on the formation type at the at least one location.

15. A method for identifying a formation type in a wellbore, the method comprising:
receiving a training dataset, the training dataset including training data logs and ground-truth measurements;
correlating a formation type at a wellbore depth in the ground-truth measurements with sensor measurements in the training data logs at the wellbore depth; and
training, using the training dataset and the correlated formation type, a machine learning model to identify a predicted formation type based on input data.

16. The method of claim 15, wherein the training data logs include at least one of a resistivity log, a spontaneous potential log, a porosity log, a density log, a clay volume log, or an effective porosity log.

17. The method of claim 15, wherein the ground-truth measurements include at least one of mud logs or geological cores.

18. The method of claim 15, further comprising:
identifying an amount of the formation type in the wellbore; and
rebalancing the training dataset based on the amount of the formation type.

19. The method of claim 18, wherein rebalancing the training dataset includes interpolating training data logs and ground-truth measurements, resulting in an approximately equal distribution of the amount of the formation type in the training dataset.

20. A system, comprising:
a processor and memory, the memory including instructions that cause the processor to:
receive input data, the input data including sensor data for a wellbore along a wellbore length of the wellbore; and
apply a machine learning model to the input data to generate an output including a formation type for at least one location along the wellbore length of the wellbore, wherein the machine learning model is trained to generate a predicted formation type based on a dataset.
